(19) United States
(12) Patent Application Publication
(10) Pub. No.: US 2016/0104168 A1
(43) Pub. Date: Apr. 14, 2016

(54) MOTORIZED VEHICLE CHAIN RESOURCE ALLOCATION

(71) Applicant: International Business Machines Corporation, Armonk, NY (US)

(72) Inventors: Stephen J. Moore, Austin, TX (US); Vanessa L. Wilburn, Austin, TX (US)

(21) Appl. No.: 14/837,084

(22) Filed: Aug. 27, 2015

Related U.S. Application Data
(63) Continuation of application No. 14/511,241, filed on Oct. 10, 2014.

(51) Int. Cl. G06Q 30/00; G08G 1/00

(52) U.S. Cl. CPC G06Q 30/018; G08G 1/22

(57) ABSTRACT

A computer implemented method of vehicle chain resource allocation includes establishing a vehicle chain network between a first motorized vehicle leading a vehicle chain and a second motorized vehicle following the first motorized vehicle in the vehicle chain. The method includes transmitting between the first and second motorized vehicles, via the vehicle chain network, a first drafting energy parameter from the first motorized vehicle and a second drafting energy parameter from the second motorized vehicle. And the method includes generating first energy credits based on the first and second drafting energy parameters and transmitting the first energy credits between the first and second motorized vehicle via the vehicle chain network.

### BACKGROUND

The present disclosure relates to motorized vehicle chains, and more specifically, to motorized vehicle chain resource allocation.

As energy costs have risen, more efficient forms of transportation have become increasingly desirable. Energy efficiencies in motorized vehicles can be gained by creating vehicle slipstream chains (“vehicle chains”). A vehicle chain, as described herein, is a group of two or more vehicles which are aligned in relatively close proximity and positioned to reduce the effect of aerodynamic drag on one or more of the vehicles in the group. As an example of a vehicle chain, one or more computer controlled driverless vehicles (“driverless cars”) could be programmed to synchronize their maneuvers to form and automatically maintain an aerodynamically efficient group. Vehicle chains can result in several benefits including lower congestion, greater road capacity, and fuel savings to each of the vehicles in the chain. By driving in this manner, motorized vehicles can increase fuel efficiency and save costs for vehicle operation.

### SUMMARY

Embodiments of the present disclosure are directed to a computer implemented method of vehicle chain resource allocation. The method includes establishing a vehicle chain network between a first motorized vehicle leading a vehicle chain and a second motorized vehicle following the first motorized vehicle in the vehicle chain. The method includes transmitting between the first and second motorized vehicles, via the vehicle chain network, a first drafting energy parameter from the first motorized vehicle and a second drafting energy parameter from the second motorized vehicle. And the method includes generating first energy credits based on the first and second drafting energy parameters and transmitting the first energy credits between the first and second motorized vehicle via the vehicle chain network.

Embodiments of the present disclosure are directed to a system of vehicle chain resource allocation. The system includes a first motorized vehicle leading a vehicle chain and a second motorized vehicle following the first motorized vehicle in the vehicle chain. The first and second motorized vehicles communicatively connected in a vehicle chain network.

The first motorized vehicle including a first database configured to store and access one or more credits and a first networking module configured to establish the vehicle chain network and to transmit and receive energy credits via the vehicle chain network. The first motorized vehicle including a first energy sensor configured to determine a first drafting energy parameter for the first motorized vehicle and a first credit generator configured to generate energy credits based on the first drafting energy parameter and a second drafting energy parameter of the second motorized vehicle.

The second motorized vehicle including a second database configured to store and access one or more credits and a second networking module configured to establish the vehicle chain network and to transmit and receive energy credits via the vehicle chain network. The second motorized vehicle including a second energy sensor configured to determine the second drafting energy parameter for the second motorized vehicle and a second credit generator configured to generate to generate energy credits based on the first drafting energy parameter and a second drafting energy parameter of the second motorized vehicle.

Embodiments of the present disclosure are directed to a computer program product for vehicle chain resource allocation. The computer program product including a computer readable storage medium having program instructions embodied therewith. The program instructions executable by a computer to cause the computer to perform a method. The method including establishing a vehicle chain network between a first motorized vehicle leading a vehicle chain and a second motorized vehicle following the first motorized vehicle in the vehicle chain. The method includes transmitting between the first and second motorized vehicles, via the vehicle chain network, a first drafting energy parameter from the first motorized vehicle and a second drafting energy parameter from the second motorized vehicle. And the method includes generating first energy credits based on the first and second drafting energy parameters and transmitting the first energy credits between the first and second motorized vehicle via the vehicle chain network.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a vehicle chain including motorized vehicles communicatively connected in a vehicle chain network according to embodiments of the present disclosure.

FIG. 2 depicts a motorized vehicle which can participate in a vehicle chain, according to embodiments of the present disclosure.

FIG. 3 depicts a flow diagram depicting a method of vehicle chain resource allocation according to embodiments of the present disclosure.

FIG. 4 depicts a flow diagram of a method of transmitting data among vehicles in the vehicle chain.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to vehicle chain resource allocation, more particular aspects relate to credit allocation among motorized vehicles in a vehicle chain. While the present disclosure is not necessarily limited to such applications, various aspects of the disclosure can be appreciated through a discussion of various examples using this context.

While the same nomenclature and same numbers are be used to identify elements throughout the disclosure, this practice is not intended to limit the scope of the disclosure. Identified elements in one figure may not be identical to other same named or identified elements in other figures.

Drafting or slipstreaming is a technique where two or more vehicles (or other moving objects) align in a relatively close group (a vehicle chain) to reduce the overall effect of aerodynamic drag on both vehicles. For example, a lead vehicle, while moving, creates a slipstream region behind the lead vehicle. The slipstream region is a wake of fluid (such as air) moving at a velocity similar to the lead vehicle. A following vehicle can take advantage of the slipstream region by following relatively close to the lead vehicle such that the following vehicle is traveling in the slipstream region. Inside the slipstream region, the following vehicle requires less power to maintain its speed than if it were moving independently. In addition, the lead vehicle also requires less power to maintain speed than it could independently, as the following vehicle reduces the effect of aerodynamic drag on the lead vehicle. This is especially true when high speeds are involved.

Because drafting vehicles require less power to maintain speed, drafting can reduce each vehicle's energy expenditure. This is especially the case for the following vehicles. For example, in some cases drafting at typical highway speeds can increase energy efficiency of following vehicles by approximately forty percent (40%). However, the lead vehicle in the vehicle chain does not receive the same energy efficiency gain as the following vehicle. Thus, it can prove helpful to motivate lead car participation by allocating credits in real time among vehicles within the vehicle chain.

A computer implemented method of vehicle chain resource allocation includes establishing a vehicle chain network between a first motorized vehicle leading a vehicle chain and a second motorized vehicle following the first motorized vehicle in the vehicle chain. The method includes transmitting, between the first and second motorized vehicles via the vehicle chain network, a first drafting energy parameter from the first motorized vehicle and a second drafting energy parameter from the second motorized vehicle. The method includes generating first energy credits in the second motorized vehicle, the first energy credits based on the first and second drafting energy parameters. The method also includes transmitting the first energy credits from the second motorized vehicle to the first motorized vehicle via the vehicle chain network.

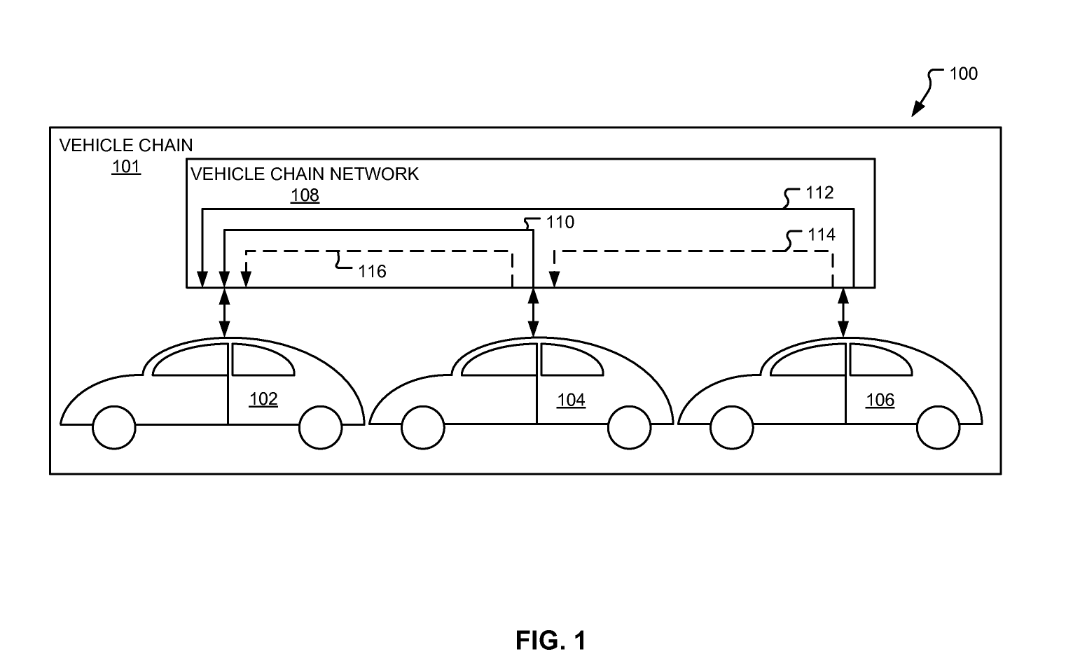

Referring now to FIG. 1, an interconnected vehicle chain system 100 is depicted according to embodiments of the present disclosure. The system 100 includes a first motorized vehicle 102, a second motorized vehicle 104, and a third motorized vehicle 106. In certain embodiments, the system 100 includes two or more motorized vehicles. The first motorized vehicle 102 is leading a vehicle chain 101 having the second and third motorized vehicles 104, 106 following the first motorized vehicle 102 in the vehicle chain 101. The first, second, and third motorized vehicles 102, 104, 106 are communicatively connected together in a vehicle chain network 108. Credit transactions 110-116 are sent between the motorized vehicles 102-106 via the vehicle chain network 108.

The motorized vehicles 102-106, as described herein, are any type of self-propelled vehicle. In embodiments, the motorized vehicles 102-106 include vehicles such as an automobile, motorized bike, bus, truck, or other suitable motorized vehicle. The motorized vehicles 102-106 include vehicles which use various types of energy for propulsion. Energy includes metered fuel, such as natural gas, diesel fuel, gasoline, and other suitable energy for propulsion such as electricity, hydrogen cells, or a hybrid of both metered and non-metered energy.

The motorized vehicles 102-106 are positioned in a vehicle chain 101 and in a drafting formation with the first motorized vehicle 102 acting as a lead vehicle and the second and third motorized vehicles 104, 106 acting as following vehicles. The motorized vehicles 102-106 can establish the vehicle chain 101 in multiple ways. In embodiments, the motorized vehicles 102-106 are computer controlled driverless vehicles configured to form and maintain the vehicle chain 101 by synchronizing driving maneuvers. For example, driverless vehicles can coordinate acceleration, speed, deceleration, turning, lane changes, and other driving maneuvers, to form the vehicle chain 101. In embodiments, the vehicle chain is formed by establishing the vehicle chain network 108, described further herein. For example, as a result of joining the vehicle chain network, the motorized vehicles 102-106 could automatically begin exchanging maneuver data. In embodiments, each of the motorized vehicles are configured to synchronize their maneuvers in line with exchanged maneuver data in order to form and maintain the vehicle chain.

In certain embodiments the vehicle chain 101 are manually formed and maintained by driver control in each of the motorized vehicles 102-106. In certain embodiments, each of the motorized vehicles 102-106 are physically connected together to form and maintain a specific distance between each of the motorized vehicles 102-106 in the chain 101. In certain embodiments, the motorized vehicles 102-106 can be on a predetermined track, such as a rail or moving along a wire.

In embodiments, each of the motorized vehicles 102-106 can be communicatively connected together by the vehicle chain network 108. The vehicle chain network allows for communication and transmission of data between the motorized vehicles 102-106 in the vehicle chain 101. In embodiments, the vehicle chain network 108 is established by a wireless connection and such as microwave communication, radio waves, cellular communication, Wi Fi, Bluetooth®, or other suitable method of wireless linking. In embodiments, the vehicle chain network 108 itself is formed from one or more various types of networks such as a wireless personal area network (PAN), local area network (LAN), wide area network (WAN), or other suitable type of wireless network.

In embodiments, the vehicle chain network 108 is established by the motorized vehicles 102-106 automatically when the motorized vehicles 102-106 come within a network range to one another. For example, if each of the motorized vehicles 102-106 have a network range of fifty feet, a vehicle chain network 108 could be established between two or more of the motorized vehicles 102-106 once they were within fifty feet of one another. In certain embodiments, users manually establish vehicle chain networks.

In embodiments, to establish the vehicle chain network 108, the motorized vehicles 102-106 perform a network negotiation and registration process and to receive a network address which identifies the motorized vehicle within the vehicle chain network 108. In embodiments the network address can include an IP address, MAC address, Host address, or other type of suitable network address.

In certain embodiments, the motorized vehicles can provide authentication information prior to establishing the vehicle chain network 108. For example, each of the motorized vehicles could first provide a username and password combination in order to join in the vehicle chain network 108. Authentication information can increase security in the vehicle chain network, especially when potentially sensitive financial information, or credits are exchanged between the motorized vehicles 102-106.

In embodiments, once the vehicle chain network 108 is established, the motorized vehicles 102-106 can exchange data within the network. In embodiments, exchanged data includes credits, energy efficiency parameters, messages, driving maneuver data, and other information.

Credits are data representations of currency which is transferrable between users of the vehicles in the vehicle chain 101. The credits can be a data representation of one or more types of currency such as vouchers, coupons, crypto currency, redeemable points, or other wirelessly transferrable currency.

In embodiments, the energy credits are an electronic voucher for funds held for the vehicle chain network 108. For example, each user of the motorized vehicles could deposit funds into one or more credit accounts associated with the motorized vehicles 102-106. Energy credits could be generated which give the credit holder access to some quantity of a credit value associated with each motorized vehicle. For example, if each user transfers twenty dollars ($20) into a credit account, energy credits could be generated which grant access to some portion of that $20 deposited in the account. As described herein, the energy credits can be generated and distributed to motive users to participate in the vehicle chain 101. After the vehicle chain 101 is disbanded, users could then redeem those energy credits for currency which is transferred to an account determined by each particular user.

Alternatively, in embodiments the credits could be a digital authorization for a transfer of a sum of currency between bank accounts owned by users of the motorized vehicles 102-106. In certain examples, the credits could be a crypto currency address for crypto currency owned by a user of the motorized vehicles 102-106.

In embodiments, credits are encrypted so that credits are transferred between vehicles in the vehicle chain while reducing the chances of interception. For example, credits represented by crypto currency, such as bitcoins, could use a cryptographic hash function to encode the address when transmitted. As an additional example, credits represented by bank account authorizations could use encryption associated with the Society for Worldwide Interbank Financial Telecommunication (SWIFT) network. Similar or other suitable encryption techniques could be used in the same or substantially similar manner to encrypt the other types of credits, as described herein.

Credit transmissions 110-116 include transfers of one or more credits between the motorized vehicles 102-106 via the vehicle chain network. For example, a first credit transmission 110 could be made directly from the second motorized vehicle 104 to the first motorized vehicle 102. In embodiments, a second credit transmission 112 could be made directly from the third motorized vehicle 106 to the first motorized vehicle 102. Direct transmission can be done where the vehicle chain network 108 is composed of a single network. In certain embodiments a first relay transmission 114 is made from the third motorized vehicle 106 to the second motorized vehicle 104, and a second relay transmission 116 is made from the second motorized vehicle to the first motorized vehicle. This allows the third motorized vehicle 106 to transmit credits to the first motorized vehicle 102 in the event that the vehicle chain network 108 includes two or more individual networks and no direct connection exists between the third motorized vehicle 106 and the first motorized vehicle 102.

Because the leading first motorized vehicle 102 has a lower energy saving effect from drafting compared to other vehicles in the vehicle chain 101, in embodiments, credits are transmitted to the first motorized vehicle from the second and third motorized vehicles in order to motivate participation in the vehicle chain. In embodiments, the amount of credits transferred among the motorized vehicles 102-106 in the vehicle chain 101 are generated based on the energy efficiency parameters.

In embodiments, energy credits are transmitted between the motorized vehicles when a motorized vehicle 102-106 leaves the vehicle chain. While the motorized vehicles can be computer controlled, a user could for example decide to terminate the vehicle chain at any point during a trip. When the vehicle chain is terminated the motorized vehicle could then calculate energy credits owed to other vehicles in the chain, generate those credits as described herein and transmit them. In certain embodiments, the energy credits are generated periodically. For example, the energy credits could be generated and transmitted once every five minutes.

Energy efficiency parameters are various parameters involving the energy use of the motorized vehicles 102-106 in the vehicle chain 101. For example, in embodiments the energy efficiency parameters include a drafting energy parameter, a non-drafting energy parameter, a rate of energy consumption, and distance traveled. The rate of energy consumption is a measurement of energy use from driving over time. In embodiments, the energy consumed includes metered fuel, such as gasoline, natural gas, or other suitable fuel. In certain embodiments, the energy consumed includes electricity, fuel cells, or other energy sources.

The drafting energy parameter is a representation of the rate of energy consumption per distance traveled while drafting. In embodiments, the drafting energy parameter is based on information from a single trip. In certain embodiments, the drafting energy parameter is aggregated from a plurality of trips. In some embodiments, the drafting energy parameter is determined by a manufacturer of each vehicle in the vehicle chain. For example the drafting

[symbol]

The non-drafting energy parameter is a representation of the rate of energy consumption per distance traveled while not drafting. In embodiments, the non-drafting energy parameter is based on information from a single trip. In certain embodiments, the non-drafting energy parameter is aggregated from a plurality of trips. In certain embodiments, the non-drafting energy parameter is based on a manufacturer rated energy efficiency rating.

In embodiments, the credits are generated based on the drafting energy parameter from each of the following motorized vehicles 104, 106. In embodiments, the drafting energy parameter is data regarding energy consumption of the motorized vehicles 102-106 while in a drafting formation. In embodiments, the drafting energy parameter is compared with a non-drafting energy parameter and energy credits are generated based on the comparison. For example, while in a drafting formation a vehicle could have an average fuel consumption rating of 61 miles per gallon (mpg) in contrast with a non-drafting energy parameter of 47 mpg.

In embodiments, the energy credits are generated based on an energy savings parameter determined based on a difference between an average non-drafting energy parameter for the following motorized vehicles 104, 106 and an average drafting energy parameter for the following motorized vehicles 104, 106.

For example, if an average drafting energy parameter is based on following motorized vehicles 104, 106 is 61 miles per gallon (mpg), and the average non drafting energy parameter is 47 mpg then the difference between the two is 14 mpg. In embodiments, the energy savings parameter is determined by the price of fuel and the difference between the drafting energy parameters and the non-drafting energy parameters. Thus, if fuel costs $5.00 per gallon and the difference between the drafting and non-drafting energy parameters is 14 mpg then the following motorized vehicles 104, 106 are saving approximately 3.6 cents per mile and the energy savings parameter is 3.6 cents per mile. However the energy savings parameter could be calculated in multiple ways depending on the preferences of the users in the vehicle chain 101.

Energy credits can be generated based on the energy savings parameter in various ways. In embodiments, energy credits equal to 50% of the energy savings parameter are generated and transmitted to the first motorized vehicle. In certain embodiments, the energy credits are generated based on splitting the energy savings parameter in proportion to the number of motorized vehicles in the vehicle chain 101 such that each motorized vehicle saves the same amount of money.

Driving maneuver data is communicated between the motorized vehicles 102-106 in various embodiments. For example, in embodiments driving maneuver is communicated where the motorized vehicles 102-106 are driverless vehicles. In certain embodiments, driving maneuver data is communicated where the motorized vehicles are not driverless, or where one motorized vehicle is a driverless vehicle and another motorized vehicle is not a driverless vehicle. In embodiments, driving data is used to coordinate driving maneuvers between the motorized vehicles 102-106 as described herein.

In certain embodiments, the vehicle chain network 108 is made up from one or more individual networks. For example, in some embodiments the vehicle chain network 108 is a single network connecting each of the motorized vehicles 102-106. In certain embodiments, the vehicle chain network 108 is two or more networks connecting two or more vehicles together.

For example, a first network could be used to connect the first motorized vehicle 102 and the second motorized vehicle 104. A second network could be used to connect the second motorized vehicle 104 and the third motorized vehicle 106. If the third motorized vehicle 106 needs to transmit data to the first motorized vehicle 102, the third motorized vehicle 106 could first transmit the data to the second motorized vehicle 104 via the second network. The second motorized vehicle 104 could then relay the data to the first motorized vehicle 102 via the first network. This is useful where the vehicle chain network is established using wireless communication links with relatively a shorter range, such as Bluetooth®. This also useful where the vehicle chain 101 is composed of numerous vehicles. In embodiments, when the vehicle chain 101 is composed of numerous vehicles, the leading vehicle is separated from one or more following vehicles by a distance such that a single network connecting each motorized vehicle in the vehicle chain is impractical.

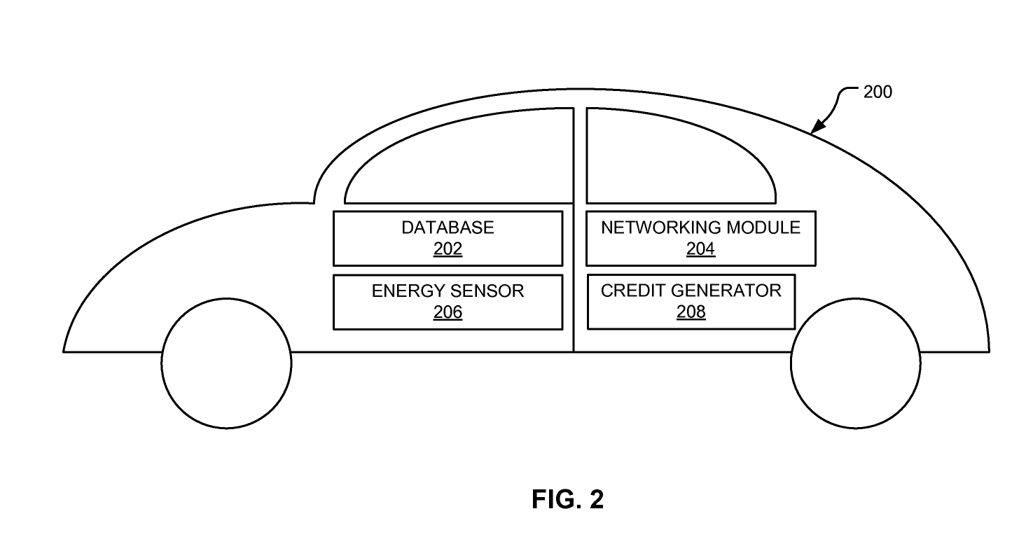

Referring now to FIG. 2, a motorized vehicle 200 is depicted which can participate in a vehicle chain, according to embodiments of the present disclosure. The motorized vehicle 200 includes a database 202, a networking module 204, an energy sensor 206, and a credit generator 208.

The database 202 stores/accesses data in the motorized vehicle 200. In embodiments, the database 202 is constructed from non-volatile memory such as hard disk drives, flash memory, or other suitable memory. In certain embodiments, the database 202 is constructed from volatile memory. In embodiments, the database 202 is configured to store data in response to a store command received from the network module 204. The database 202 is configured to access data in response to an access command received from the networking module 204. In embodiments, the database 202 stores data such as energy efficiency parameters, messages, driving data, credits, and other data as described herein. In embodiments, the database 202 is configured to store and access one or more credits.

The networking module 204 communicates and transmits data between one or more motorized vehicle as described herein. In embodiments, the data includes energy efficiency parameters, messages, driving data, credits, and other information. In embodiments, the networking module 204 contains a transmitter, a receiver, and networking logic. In embodiments, the networking logic establishes a vehicle chain network, as described herein to transmit and receive data via the vehicle chain network.

The energy sensor 206 senses energy parameters in the motorized vehicle 200. In embodiments the energy sensor 206 includes a flow sensor configured to sense the rate of metered fuel consumption in the motorized vehicle. In certain embodiments, the energy sensor 206 includes an odometer configured to sense a distance traveled by the motorized vehicle 200. In embodiments, the flow sensor and the odometer are used to determine the drafting energy parameter and non-drafting energy parameter for the motorized vehicle, as described herein.

The credit generator 208 is a logic device configured to generate credits based on energy efficiency parameters of the motorized vehicle, as described herein. In embodiments, the credit generator 208 is configured to generate at least two types of credits, energy credits and test credits. Energy credits are digital representations of currency as described herein. In embodiments, the credit generator 108 includes logic to encrypt energy credits for transmission, as described herein.

In embodiments, test credits are approximations of energy credits owed to the user of the motorized vehicle 200. The test credits are used to validate the energy credits received by the motorized vehicle 200. In embodiments, the test credits are generated in the same or substantially similar manner as the energy credits as an approximation of energy credits which the motorized vehicle expects to receive. In embodiments, the motorized vehicle 200 has access to energy efficiency parameters of other motorized vehicles in the vehicle chain via the networking module 204 to generate the test credits.

For example, where energy credits are a digital voucher for funds deposited in a credit account, the test credits could be used to determine whether the credit account contains enough funds to cover energy credits owed to the motorized vehicle 200. If the credit account contains a credit value of funds greater than or approximately equal to the test credits, then the energy credits are validated. If the credit account contains funds less than the amount specified by the test credits then the energy credits are not validated.

In embodiments, the motorized vehicle 200 can generate test credits to validate energy credits periodically. For example, test credits could be generated every five minutes to confirm during the trip that the energy credits owed to the motorized vehicle do not exceed funds within the credit account, as described herein. In embodiments, the motorized vehicle 200 can request that additional funds be deposited in the credit account in response to determine that the energy credits are not validated. In certain embodiments, the motorized vehicle can terminate participation in the vehicle chain in response to determining that the energy credits are not validated.

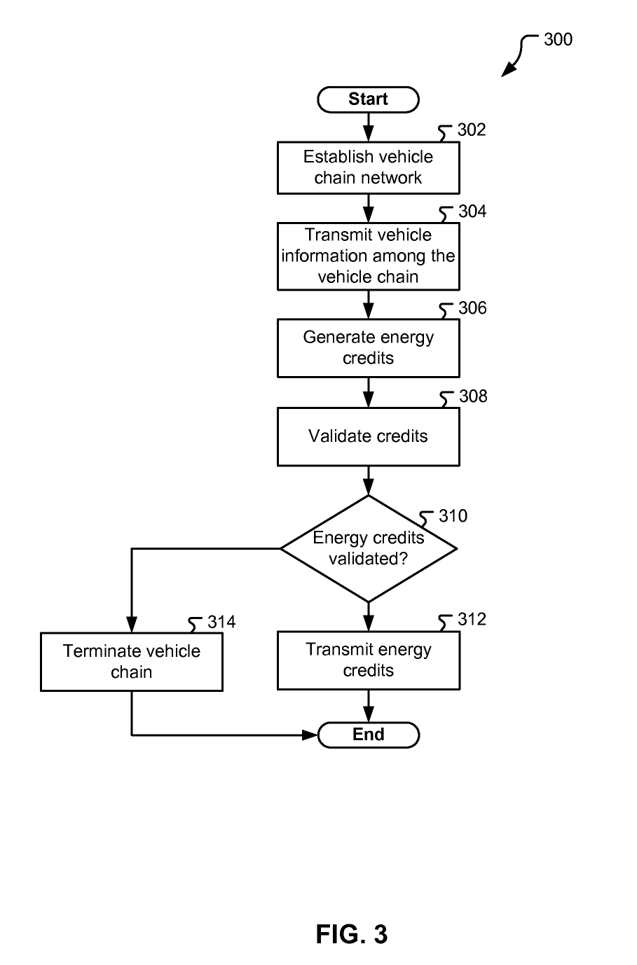

Referring now to FIG. 3, a flow diagram depicting a method 300 of vehicle chain resource allocation is seen according to embodiments of the present disclosure. In operation 302, a vehicle chain network is established between two or more motorized vehicles in the vehicle chain. In embodiments the vehicle chain network is established through wireless links such as microwave communication, radio waves, cellular communication, Wi Fi, Bluetooth®, or other suitable method of wireless linking as described herein. In embodiments, the vehicle chain network includes one or more individual networks as described herein.

In operation 304, vehicle chain information is transmitted among the motorized vehicles in the vehicle chain network. Data is exchanged between the motorized vehicles via the vehicle chain network as described herein. In embodiments, the data includes energy efficiency parameters, messages, driving maneuver data, credits, and other information.

In operation 306, energy credits are generated for vehicles in the vehicle chain network. In embodiments, credits are the same or substantially similar as described herein. In embodiments energy credits are credits which are generated by one or more of the following vehicles and transmitted to the leading vehicle in the vehicle chain to motivate participation of the leading vehicle in the vehicle chain.

In operation 308, the energy credits are validated in the lead vehicle. In embodiments, credits are validated by determining test credits which are approximations of energy credits owed to a user of a motorized vehicle. For example, the leading vehicle can generate test credits which are approximations of energy credits owed to the user of the leading vehicle. In embodiments, test credits are based on the energy parameter from the motorized vehicles in the vehicle chain network, in the same or substantially similar manner as the energy credits, as described herein. Where the energy credits are digital representations of some quantity of funds held in a credit account, the test credits can be compared to the credit value of the credit account to see if sufficient funds are held to cover the expected energy credits. In embodiments the leading motorized vehicle validates, prior to receiving the energy credits, the energy credits using the test credits.

In decision block 310, if the energy credits are validated, as described herein, then the method 300 progresses to operation 312. In operation 312, the energy credits are transmitted among the motorized vehicles in the vehicle chain network, as described herein.

If the energy credits are not validated, then in decision block 310 the method 300 progresses to operation 314. In operation 314 the vehicle chain is terminated. In embodiments, if insufficient funds exist to motivate the lead vehicle in the vehicle chain, then the lead vehicle automatically terminates the vehicle chain.

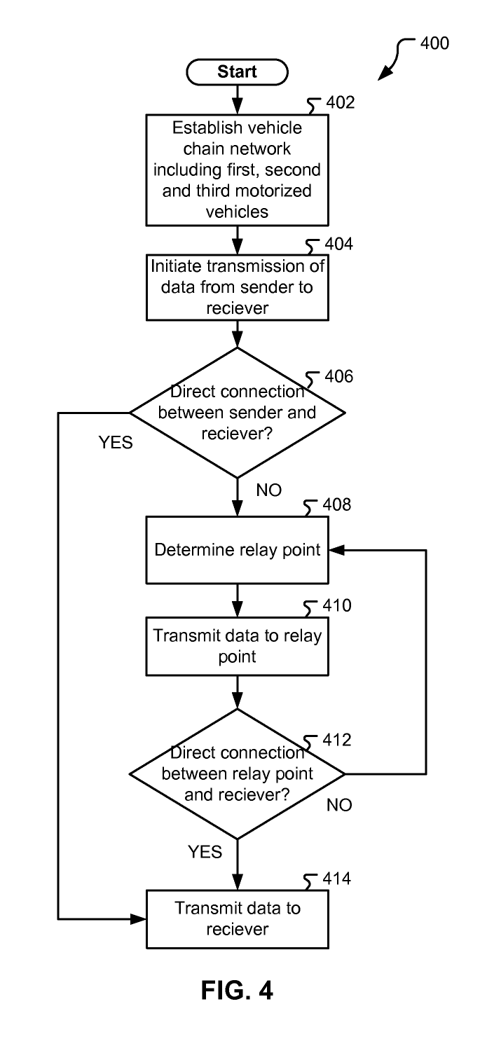

Referring now to FIG. 4, a flowchart depicting a method of transmitting data among vehicles in the vehicle chain is seen according to embodiments of the present disclosure. In operation 402, a vehicle chain network is established between a first, second, and third motorized vehicle. In embodiments, the vehicle chain network is the same or substantially similar as described herein. In embodiments, the first, second, and third motorized vehicles are the same or substantially similar as the motorized vehicles as described herein.

In operation 404, transmission of data is initiated from a sender motorized vehicle (“sender”) to a receiver motorized vehicle (“receiver”) in the vehicle chain. In embodiments, data is transmitted between the motorized vehicles via the vehicle chain network as described herein. In embodiments, the vehicle chain network is made of one network connecting each vehicle in the vehicle chain. In certain embodiments, the vehicle chain network is made from two or more networks each connecting two or more motorized vehicles. For example, the vehicle chain network could include a first network connecting the first motorized vehicle and the second motorized vehicle. A second network could connect the second motorized vehicle and the third motorized vehicle. In embodiments, the data is the same or substantially similar as described herein. For example, in embodiments, the data includes energy efficiency parameters, messages, driving data, credits, and other information. In embodiments, data is transmitted automatically in the vehicle chain network. For example, the data could be transmitted periodically every five to ten miles to provide an aggregate of energy efficiency parameters or other data over the course of time driving. In certain embodiments, data is transmitted every tenth of a second to half of a second so that data, such as driving data, is provided nearly instantaneously and shared with the other motorized vehicles. In certain embodiments, data is transmitted in response to a request for information or other command.

If a direct connection exists between the sender and the receiver in the vehicle chain network then in decision block 406 the method 400 progresses to operation 414. In operation 414 data is transmitted to the receiver via the vehicle chain network, as described herein. If no direct connection exists between the sender and the receiver in the vehicle chain network, then in decision block 406, the method 400 progresses to operation 408.

In operation 408 a relay point is determined. In embodiments, where no direct connection exists between the sender and the receiver, an indirect connection exists though one or more individual networks making up the vehicle chain network, as described herein. For example, where the vehicle chain network is made up of the first and second network as described above, data can be transmitted between the first and third motorized vehicles by being relayed through the second motorized vehicle. In certain embodiments, there are numerous motorized vehicles in the vehicle chain and the vehicle chain is made up of numerous individual networks. For example, data could be relayed two or more times between various vehicles in order to be transmitted between the sender and the receiver. In embodiments, the relay point is determined by a position in the vehicle chain which reduces the number of relays needed to be transmitted to the receiver. In embodiments, the relay point has a direct network with the sender and is closest to the receiver relative to other vehicles in the vehicle chain.

In operation 410 data is transmitted to the relay point. In embodiments, the data is transmitted to the relay point via the vehicle chain network as described herein. If there is a direct connection between the relay point and the receiver motorized vehicle, then in decision block 412, the method 400 progresses to operation 414. In operation 414 data is transmitted then to the receiver via the vehicle chain network, as described herein.

In embodiments, if there is no direct connection between the relay point and the receiver motorized vehicle, then in decision block 412, the method 400 resets to operation 408 and a new relay point is determined as described herein. In embodiments, the old relay point then becomes the sender and transmits to the receiver via the new relay point as described herein. In embodiments, the method then progresses until there is a direct connection between the relay point and the receiver. In embodiments the method then progresses to operation 414 as described herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer implemented method of vehicle chain resource allocation, the method comprising:
establishing a vehicle chain network between a first motorized vehicle leading a vehicle chain and a second motorized vehicle following the first motorized vehicle in the vehicle chain;
transmitting between the first and second motorized vehicles, via the vehicle chain network, a first drafting energy parameter from the first motorized vehicle and a second drafting energy parameter from the second motorized vehicle;
generating first energy credits based on the first and second drafting energy parameters; and
transmitting the first energy credits between the first and second motorized vehicle via the vehicle chain network.

2. The method of claim 1, further comprising:
generating first test credits based on the first drafting energy parameter from the first motorized vehicle and a second drafting energy parameter from the second motorized vehicle;
transmitting the first test credits between the first and second motorized vehicle via the vehicle chain network;
determining that a credit account associated with the second motorized vehicle contains a credit value greater than or equal to the first test credits; and
validating, prior to transmitting the first energy credits, the first test credits in response to determining that the credit account contains a credit value greater than or equal to the first test credits.

3. The method of claim 1, further comprising:
sensing, via a first energy sensor in the first motorized vehicle, a first rate of energy consumption in the first motorized vehicle and sensing, via a second energy sensor in the second motorized vehicle, a second rate of energy consumption in the second motorized vehicle; and
sensing, via a first odometer in the first motorized vehicle, a first distance traveled by the first motorized vehicle and sensing, via a second odometer in the second motorized vehicle, a second distance traveled by the second motorized vehicle;
wherein the first drafting energy parameter is based on the first rate of energy consumption and the first distance and wherein the second drafting energy parameter is based on the second rate of energy consumption and the second distance.

4. The method of claim 1, further comprising:
establishing the vehicle chain network between the first motorized vehicle, the second motorized vehicle, and a third motorized vehicle following the second motorized vehicle in the vehicle chain.
transmitting between the first, second, and third motorized vehicles via the vehicle chain network, the first drafting energy parameter from the first motorized vehicle, the second drafting energy parameter from the second motorized vehicle, and a third drafting energy parameter from the third motorized vehicle;
generating second energy credits based on the first, second and third drafting energy parameters; and
transmitting the second energy credits between the first and third motorized vehicles via the vehicle chain network.

5. The method of claim 4, wherein:
the second energy credits are transmitted between the third motorized vehicle and the first motorized vehicle by a method including:
transmitting the second energy credits from the third motorized vehicle to the second motorized vehicle via the vehicle chain network; and
transmitting the second energy credits to the first motorized vehicle from the second motorized vehicle via the vehicle chain network.

6. The method of claim 5 further comprising:
generating second test credits based on the first drafting energy parameter from the first motorized vehicle and the third drafting energy parameter from the third motorized vehicle;
transmitting the second test credits between the first and third motorized vehicles;
determining that a credit account associated with the third motorized vehicle contains a credit value greater than or equal to the second test credits; and
validating, prior to transmitting the second energy credits, the second test credits in response to determining that the credit account contains a credit value greater than or equal to the second test credits.

7. The method of claim 1, further comprising:
determining a first non-drafting energy parameter and the first drafting energy parameter for the first motorized vehicle and a second non-drafting energy parameter and the second drafting energy parameter for the second motorized vehicle;
determining an average non-drafting energy parameter based on the first and second non-drafting energy parameters;
determining an average drafting energy parameter based on the first and second drafting energy parameters; and
determining an energy savings parameter for the second motorized vehicle based on a difference between the average drafting energy parameter and the average non-drafting energy parameter;
wherein the first energy credits are generated based on the energy savings parameter.
